(19) United States
(12) Patent Application Publication
(10) Pub. No.: US 2010/0253797 A1
(43) Pub. Date: Oct. 7, 2010

(54) SMART FLASH VIEWER

(75) Inventors: Yuri Arshavski, Netanya (IL); Eduard Oks, Bat-Yam (IL); Noam Sorek, Zikhron-Yaakov (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Suwon-si (KR)

(21) Appl. No.: 12/416,394

(22) Filed: Apr. 1, 2009

(51) Int. Cl. H04N 5/228

(52) U.S. Cl. 348/222.1; 348/E05.031

(57) ABSTRACT

A method for generating a preview image of an item to be photographed using flashlights, wherein said preview image is generated without any added light, comprises the steps of: (a) calculating the distance between a portion of the item to be photographed and the camera; (b) calculating the flash light dissemination on the area of said portion, using the distance to said portion and the known flash power to be applied; (c) recalculating captured exposure parameter according to the information gathered from the surface of said portion; and (d) changing the brightness of the preview image by using the calculated lighting parameters at each location.

### FIELD OF THE INVENTION

The present invention relates to the field of photography and, more particularly, to the field of flash photography.

### BACKGROUND OF THE INVENTION

One of the most frustrating problems of users that want to take pictures badly-lit places is that the preview image is always darker than the image that will eventually be captured using the flash, because the flash “burns” information located in close regions and does not affect surfaces located in farther regions. The brightness level of objects in photo to be captured with flash is therefore very difficult to predict, as mentioned before, because the object's brightness is strongly dependent on the distance between the object and the flash device. Because of this inherent problem, a photographer finds it difficult to choose a good capturing position from which to take flash photography, and this problem prevents many users from taking good quality photos in low illumination places.

Some modern cameras use flashlight during preview to solve the problem. While such a system can be used for still cameras, it is power consuming, which is extremely problematic, especially for mobile phones for which power management is an important issue.

Other solutions provided in the art include one of the following (or combinations of the following):
(1) Infrared pre-flash
(2) Led lighted preview
(3) Gained preview.

However, private solutions all suffer from these advantages and limitations, such as:
1. The infrared pre-flash delivers a weak light and cannot efficiently help the user to find a good position. The preview image and the photo eventually captured with the flashlight are very different.
2. The led lighted preview is a power consuming method.
3. The gained preview allows seeing a preview with more details but it doesn't solve the problem of the non-uniform dispersion of flash light. This method also doesn't solve the problem of differences in preview and flashed picture, in which all picture details have been gained by a function such as the gamma correction that doesn't consider the distance factor. Therefore the captured picture illumination is different than the preview image. Usually the gained preview is used to simplify the selection of a picture area.

Therefore, according to the known art, unless an extremely high power consumption is allowed, the user has no means to obtain a real preview showing the image that will be captured with the flash, which prevents him from composing the image correctly.

### SUMMARY OF THE INVENTION

The invention relates to a method for generating a preview image of an item to be photographed using flashlights, wherein said preview image is generated without any added light, comprising the steps of:
(a) calculating the distance between a portion of the item to be photographed and the camera;
(b) calculating the flash light dissemination on the area of said portion, using the distance to said portion and the known flash power to be applied;
(c) recalculating captured exposure parameter according to the information gathered from the surface of said portion; and
(d) changing the brightness of the preview image by using the calculated lighting parameters at each location.

According to an embodiment of the invention the item is a human being and the portion is a human face.

According to another embodiment of the invention the distance to the face location is calculated using a face detection algorithm.

### BRIEF DESCRIPTION OF THE FIGURES

In the figures:

FIG. 1(A) is a preview image as seen in a badly-lit room without using a preview mode;

FIG. 1(B) is the same scene as in FIG. 1(A), as captured using the mobile phone flash;

FIGS. 2 and 3 illustrate the different illumination in the face area as a function of distance between flash and object:

FIG. 2(A) is a preview image as seen in a badly-lit room using a simulation of the smart flash preview mode;

FIG. 2(B) is the same scene as captured using the mobile phone flash; and

FIGS. 3(A) and (B) are the preview and picture of the same scene of FIG. 2, but captured from a different distance.

### DETAILED DESCRIPTION OF THE INVENTION

The invention solves the aforementioned problem for portrait mode capturing. Although the invention is described in relation to the capturing of human portraits, for the sake of simplicity, it should be understood that it is by no means limited to specific objects to be captured by flash photography, and the invention is applicable, mutatis mutandis, to any other object, as would be further discussed below.

Referring now for the sake of illustration to the taking of photographs of a portrait image, the method of the invention is based, inter alia, on the following practical considerations:
The face region is the most interesting region of the portrait image. Its quality should be as good as possible.
Human faces (including children's) have similar sizes.

According to an embodiment of the invention the distance between the camera and the face on the preview image is calculated and the preview image is automatically changed in real time, by simulating the use of the flash light during the photo capture. The user can see, when in camera preview mode, and image in the face area that is very similar to the photo captured with flash light, without using the actual flash light. The method of the invention does not consume additional power and may extend the battery lifetime as compared with all prior art methods.

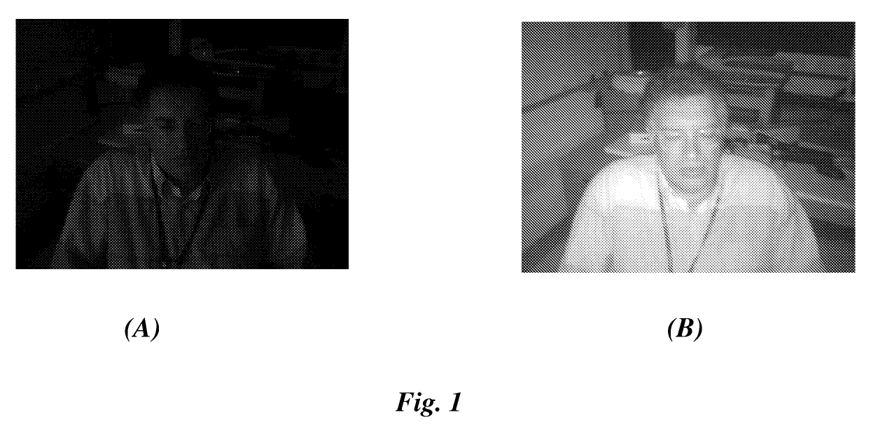

An example of a problematic shot in badly-lit scenes is shown in FIG. 1, in which image (A) is a preview image as seen in preview mode without using the invention, and image (B) is the very same image as seen in captured picture mode. The images are dramatically different.

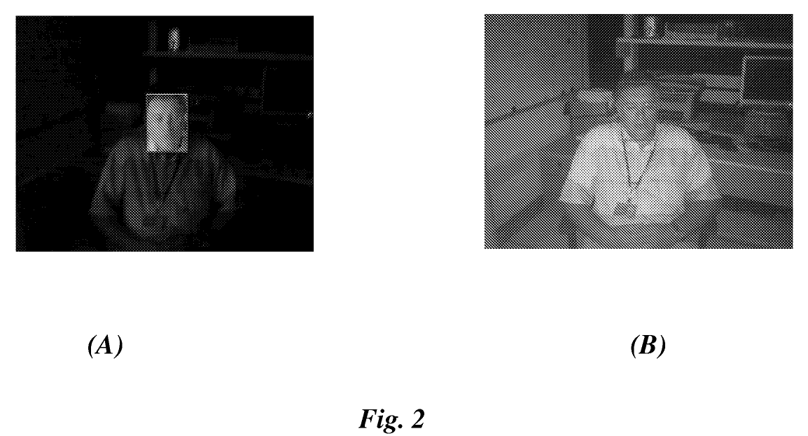

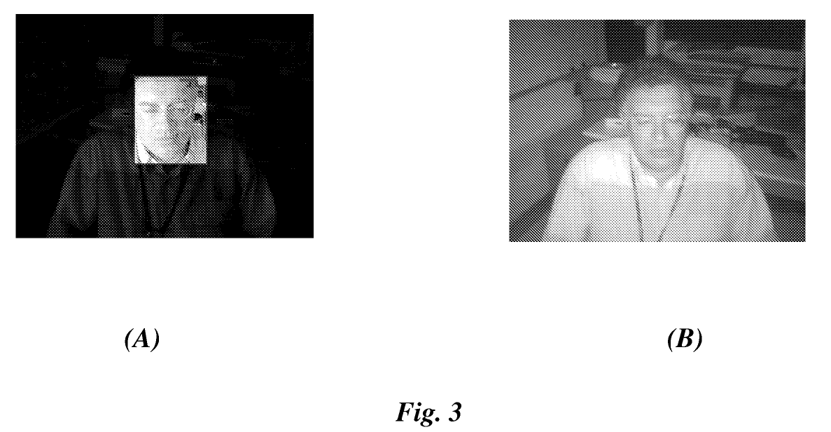

An example of the result attainable when operating according to the invention is shown in FIGS. 2 and 3, in which the images marked (A) are preview images as seen in a badly-lit room using the smart flash preview mode, without the use of any added light, and the images marked (B) are the very same pictures captured using the flash. Here it is seen that the area of the face is very similar in the preview and in the captured images.

As stated above, the invention will now be illustrated using the human face as an example. The method of the invention employs a face detection algorithm, and exploits the fact that human faces have similar sizes. These elements are used to compute the distance between the human face location and the camera device. The following steps illustrate the process according to one embodiment of the invention:

In the first step a face detection algorithm is used to calculate the distance to the face location. Any suitable face detection algorithm can be used. One example is the face detection method devised by Viola and Jones, which uses Haar-like features [Viola and Jones, “Rapid object detection using boosted cascade of simple features”, Computer Vision and Pattern Recognition, 2001].

In the second step the flash light dissemination is calculated on the face area, using the distance to the face, and the known flash power.

In the third step, calculated light dissemination parameters are used to simulate the face area illumination. In the case of saturated or dark face areas, the calculated information can be used for exposure and flash parameters correction. Also the photographer can choose a new position at a different distance, until a satisfactory preview face area simulated illumination is obtained.

The distance between the human face location and the Camera device can be calculated as

D=b*f*r*z/s

wherein:
b is the experimental coefficient;
f is the camera distortion factor (1—for most cameras), obtained from the camera's optic relative illumination spec parameters;
r is the resolution, defined by a user interface parameter (such as 1536×2048, r=3(M), for example);
z is the optic zoom factor, obtained from a camera SW;
s is the face size, obtained from a face detection algorithm (camera SW).

The illumination of an object lighted by flash light can be described by the following formula:

$$I = {I}_{0} + μ * cos ( α ) * \frac{1}{{D}^{2}}$$

### Wherein

I is the object illumination (calculated as an average value of the intensity on the face area);
I₀ is the object illumination without flash light (the average value of intensity on the face area);
μ is an experimental coefficient (flash power);
α is the ray angle (obtained from the camera optic spec);
D is the distance between camera device and object.

As explained above, the power management problem is of great importance for all cameras, but it is even more critical for digital cameras incorporated in digital phones, for which the power management is an even more critical issue. Most digital camera modules currently used in camera phones have a 50- to 60-degree field of view and need a minimum of 3 to 5 lux to capture a good picture at a distance of 0.5-4 m.

On average, a photographer spends around 20-30 seconds generating a preview. The used led flash wastes so much power to illuminate in preview mode, that most mobile phone cameras flashes provide a maximal shooting distance of less than 3-4 m. It should be noted that the flash capture time is typically less than 0.5 seconds. Therefore, decreasing the flash time by 40 folds increases the maximum shooting distance to 20 m (the power expense is proportional to D²) with the same power safety and the same illumination.

On the other hand, a long time preview led flash creates a problem related to human eyes sensitivity. A human can suffer only a few seconds of strong led light, which is usually not enough to complete the preview. Therefore pictures taken using long-time flashes very often show closed eyes (as seen in the appended figures.)

The above method is illustrated in FIGS. 1-3. The dark scene preview is shown in FIG. 1(A), which does not show any details of the picture captured using a flash (FIG. 1(B)). The pictures in FIGS. 1 and 2 were captured at a the distance of 2 and 1 m, respectively. FIGS. 2 and 3(A) show preview images with detected faces (in a rectangle). The sizes of those rectangles allow to calculate the distance from camera to faces. The above method allows to compute and simulate the illumination of the faces, and to show them as if lighted by the flash, without actually using it (FIGS. 2, 3(A)). The face illumination simulations ((FIGS. 2, 3(A)) are very similar to the pictures captured with flash ((FIGS. 2, 3(B)).

As explained before, the invention is in no way limited to images of human beings. Because the critical information needed to pay out the invention is the knowledge of the size of a specific area of the image being taken, it is equally applicable to any other item to be photographed. In the case of a human face the basic size and shape parameters can be present in the camera and be provided by the factory. However, when it is desired to use the method of the invention for items that are not preset in the camera it is possible to feed the relevant parameters at the user's level.

As will be apparent to a skilled person from the above description, the invention provides considerable advantages. Particularly:
1. The invention provides to the user an enhanced natural preview mode that encapsulates flash light dissemination on a surface, without actually using the flash. This helps the user to obtain a better understanding of the image that he wishes to capture.
2. The smart flash viewer helps to calculate better exposition parameters (like exposure time, gain and other) for camera preview and capture mode.
3. The invention helps the user to better compose the image before actual picture taking, and to step backward or forward if needed according to the predicted image quality in the preview.

All the above description and examples have been given for the purpose of illustration only and are not intended to limit the invention in any way. As will be apparent to the skilled person, many modifications can be carried out to be above description, to capture different images using different apparatus, all without exceeding the scope of the invention.

1. A method for generating a preview image of an item to be photographed using flashlights, wherein said preview image is generated without any added light, comprising the steps of:
(a) calculating the distance between a portion of the item to be photographed and the camera;
(b) calculating the flash light dissemination on the area of said portion, using the distance to said portion and the known flash power to be applied;
(c) recalculating captured exposure parameter according to the information gathered from the surface of said portion; and
(d) changing the brightness of the preview image by using the calculated lighting parameters at each location.

2. A method according to claim 1, wherein the item is a human being and the portion is a human face.

3. A method according to claim 2, wherein the distance to the face location is calculated using a face detection algorithm.
